(19) United States
(12) Patent Application Publication
(10) Pub. No.: US 2026/0352908 A1
(43) Pub. Date: Nov. 5, 2026

(54) Monitoring Item Characteristics from Video Stream Data Using a Knowledge Graph

(71) Applicant: eBay Inc., San Jose, CA (US)

(72) Inventor: Shrivatsan Navalpakkam Rajagopalan, San Jose, CA (US)

(73) Assignee: eBay Inc., San Jose, CA (US)

(21) Appl. No.: 19/198,246

(22) Filed: May 5, 2025

(51) Int. Cl. H04N 21/254; H04N 21/431; H04N 21/658

(52) U.S. Cl. CPC H04N 21/2542; H04N 21/4316; H04N 21/6581

(57) ABSTRACT

Monitoring item characteristics from video stream data using a knowledge graph is described. A first computing device (e.g., a receiving computing device or a server device) receives video stream data including a set of frames and audio data from a second computing device (e.g., a transmitting computing device). The first computing device obtains respective vector representations of the set of frames as output from a learning model. The first computing device determines items and first characteristics of the items from the frames and audio data based on the items being associated with vector representations matching the respective vector representations within a threshold value. The first computing device determines one or more second characteristics of the items, including at least one characteristic different from the first characteristics. The first computing device transmits or outputs the video stream data and the different characteristic for display at a computing device (e.g., the receiving computing device).

### BACKGROUND

Computing devices can implement various applications to manage digital media content. The digital media content can include, but is not limited to, video stream data, image data, and item listing data, among other examples. In some examples, a computing device can share (e.g., send, transmit, output) digital media content to another computing device. For example, the computing device can send a digital video content for display at the other computing device.

The computing device may use machine learning and/or artificial intelligence techniques to generate information by analyzing patterns in data. The computing device can implement one or more learning models, such as artificial intelligence models and/or machine learning models, to capture patterns and relationships in the data, enabling the learning models to make predictions or decisions on new, unseen data.

### SUMMARY

A server device in a server system receives video stream data from a computing device. The video stream data includes a set (e.g., series) of digital frames and audio data. The server device generates (e.g., obtains, receives) vector representations of each digital frame in the set of digital frames by providing the set of digital frames as input to a learning model. The server device determines one or more items and characteristics of the one or more items from the digital frames and the audio data, such as by parsing the audio data and/or comparing the vector representations to stored vector representations of one or more known items with corresponding characteristics. The server device determines one or more additional characteristics of the items that differ from the characteristics of the items identified from the video stream data. The computing device transmits the video stream and an indication of the additional characteristics for display at the computing device and/or at one or more other computing devices.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIGS. 1 and 2 are illustrations of environments in an example implementation that is operable to employ techniques described herein.

FIG. 3 depicts an example procedure for monitoring item characteristics from video stream data using a knowledge graph.

FIGS. 4 and 5 depict example user interfaces for monitoring item characteristics from video stream data using a knowledge graph.

FIGS. 6 through 8 depict procedures in example implementations of monitoring item characteristics from video stream data using a knowledge graph.

FIG. 9 illustrates an example of a system that includes an example computing device that is representative of one or more computing systems and/or devices that may implement the various techniques described herein.

### DETAILED DESCRIPTION

### Overview

Techniques for monitoring item characteristics from video stream data using a knowledge graph are described. A computing device obtains video stream data (e.g., using one or more sensors, including camera sensors and audio sensors, among other examples) for transmission to a target computing device. The video stream data can include a set of frames (e.g., digital frames that when compiles are representative of a video) and audio data. In some cases, the computing device sends (e.g., transmits, outputs) the video stream data to a server device of a server system and/or to the target computing device. The server device and/or the target computing device obtain respective vector representations of the frames as output from a learning model. The server device and/or the target computing device determine (e.g., identify, detect) one or more items and corresponding characteristics of the items from the video stream data by comparing the vector representations to defined or known vector representations. The server device and/or the target computing device determine that one or more additional characteristics of the items are different from the characteristics determined from the video stream data. In some cases, such as if the server device determines the difference in characteristics, the server device transmits the video stream data and an indication of the different characteristics to the target computing device. Additionally, or alternatively, the target computing device outputs the video stream data and the different characteristics for display.

In some examples, a computing device can broadcast (e.g., transmit, output, send) video stream data to one or more target computing devices. The computing device can broadcast the video stream data in real time or in near real time (e.g., with less than a threshold delay between when the computing device captures and sends the video stream data and when one or more target computing devices receive the video stream data). However, conventional techniques for broadcasting video stream data fail to detect (e.g., determine, identify) errors and inconsistencies in the video stream data. For example, frames in the video stream data can include one or more items that are listed via an online marketplace application and can include audio data that describes the items. Conventional techniques do not verify that the description (e.g., the audio data) is accurate based on the items in the frames. Further, conventional techniques for broadcasting video stream data may not provide contextual information related to the content of the video stream data (e.g., one or more items represented by the video stream data). The lack of contextual information leads to inefficient use of computational resources (e.g., memory, processing, and power resources) due to the computing device receiving additional instructions to retrieve the contextual information independent of the video stream data.

As described herein, to reduce errors and inconsistencies in video stream data, as well as to reduce inefficiencies related to broadcasting video stream data without contextual information, a target computing device and/or a server device in a server system can implement one or more learning models (e.g., machine learning models and/or artificial intelligence models) to verify accuracy of video stream data received from a computing device and to access and display relevant contextual information at the target computing device. For example, the target computing device and/or the server device can process the frames and the audio data of the video stream data using one or more learning models to detect inconsistencies between characteristics of one or more items represented by the video stream data (e.g., included in the frames or described in the audio data) and known characteristics of the items. For example, if the audio data includes a description of an item as being new, but the frames show visible signs of wear or damage on the item, then the target computing device and/or the server device detects (e.g., determines, identifies, flags) the inconsistency.

Additionally, or alternatively, the target computing device and/or the server device can process the video stream data and contextual data related to the items represented by the video stream data (e.g., obtained from inventory databases, from user engagement platforms, profiles related to one or more users, among other examples) using one or more learning models to detect relevant contextual information for the items. In some cases, the server device sends the video stream data and an indication of the inconsistent (e.g., different) characteristics to the target computing device. Additionally, or alternatively, the server device can send the video stream data and the relevant contextual information to the target computing device. The target computing device outputs the video stream data (e.g., at a user interface of the target computing device) and can optionally superimpose or overlay the indication of the inconsistent characteristics and/or the relevant contextual information.

By using one or more learning models to detect inconsistencies in characteristics of one or more items represented in video stream data, the target computing device and/or the server device can reduce errors and misinformation in the video stream data. Further, by using the one or more learning models to obtain relevant contextual information for the items, the target computing device and/or the server device can reduce the use of computational resources related to retrieving and displaying contextual information after the video stream data is displayed to a user. For example, the target computing device and/or the server device can proactively identify and output (e.g., present, display) relevant details about items in the video stream data, reducing or eliminating additional queries by users.

In some aspects, the techniques described herein relate to a computer-implemented method performed by a first computing device, the computer-implemented method including receiving, from a second computing device, video stream data including a set of frames and audio data, obtaining, as output from at least one learning model, respective vector representations of the set of frames based on providing the set of frames as input to the at least one learning model, determining, from the set of frames and the audio data, one or more items and one or more first characteristics of the one or more items based on the one or more items being associated with vector representations that match the respective vector representations of the set of frames within a threshold value, determining one or more second characteristics of the one or more items, where the one or more second characteristics of the one or more items include at least one characteristic that is different from the one or more first characteristics, and transmitting, for display at a third computing device, the video stream data and the at least one characteristic that is different from the one or more first characteristics.

In some aspects, the techniques described herein relate to a computer-implemented method, where determining the one or more first characteristics of the one or more items includes parsing the audio data to obtain the one or more first characteristics of the one or more items.

In some aspects, the techniques described herein relate to a computer-implemented method, where determining the one or more second characteristics of the one or more items includes obtaining, as output from at least one additional learning model, an indication of one or more additional items that are within a threshold similarity to the one or more items, and retrieving metadata for the one or more additional items, where the metadata includes the one or more second characteristics.

In some aspects, the techniques described herein relate to a computer-implemented method, where determining the one or more second characteristics of the one or more items includes obtaining, as output from at least one additional learning model, the one or more second characteristics based on providing an indication of the one or more items and user information associated with the second computing device as input to the at least one additional learning model, where the one or more second characteristics are determined based on trend data corresponding to the user information.

In some aspects, the techniques described herein relate to a computer-implemented method, where determining the one or more second characteristics of the one or more items includes receiving, from the second computing device, sensor data that indicates the one or more second characteristics.

In some aspects, the techniques described herein relate to a computer-implemented method, further including transmitting, for display at the second computing device, a notification that the at least one characteristic is different from the one or more first characteristics.

In some aspects, the techniques described herein relate to a computer-implemented method, further including causing the third computing device to superimpose the at least one characteristic onto the video stream data in real time.

In some aspects, the techniques described herein relate to a computer-implemented method, further including causing the third computing device to display a notification that the at least one characteristic is different from the one or more first characteristics.

In some aspects, the techniques described herein relate to a computer-implemented method, further including receiving, from the third computing device, a request for the at least one characteristic, where transmitting the at least one characteristic is based on the request, where at least one of the one or more first characteristics or the one or more second characteristics include respective categories of the one or more items, respective physical attributes of the one or more items, or respective conditions of the one or more items.

In some aspects, the techniques described herein relate to a computer-implemented method performed by a first computing device, the computer-implemented method including receiving, from a second computing device, video stream data including a set of frames and audio data, obtaining, as output from at least one learning model, respective vector representations of the set of frames based on providing the set of frames as input to the at least one learning model, determining, from the set of frames and the audio data, one or more items and one or more first characteristics of the one or more items based on the one or more items being associated with vector representations that match the respective vector representations of the set of frames within a threshold value, determining one or more second characteristics of the one or more items, where the one or more second characteristics of the one or more items include at least one characteristic that is different from the one or more first characteristics, and outputting the video stream data and the at least one characteristic that is different from the one or more first characteristics for display.

In some aspects, the techniques described herein relate to a computer-implemented method, where determining the one or more first characteristics of the one or more items includes parsing the audio data to obtain the one or more first characteristics of the one or more items.

In some aspects, the techniques described herein relate to a computer-implemented method, where determining the one or more second characteristics of the one or more items includes obtaining, as output from at least one additional learning model, an indication of one or more additional items that are within a threshold similarity to the one or more items, and retrieving metadata for the one or more additional items, where the metadata includes the one or more second characteristics.

In some aspects, the techniques described herein relate to a computer-implemented method, where determining the one or more second characteristics of the one or more items includes obtaining, as output from at least one additional learning model, the one or more second characteristics based on providing an indication of the one or more items and user information associated with the second computing device as input to the at least one additional learning model, where the one or more second characteristics are determined based on trend data corresponding to the user information.

In some aspects, the techniques described herein relate to a computer-implemented method, where determining the one or more second characteristics of the one or more items includes receiving, from the second computing device, sensor data that indicates the one or more second characteristics, where at least one of the one or more first characteristics or the one or more second characteristics include respective categories of the one or more items, respective physical attributes of the one or more items, or respective conditions of the one or more items.

In some aspects, the techniques described herein relate to a computer-implemented method, further including transmitting, for display at the second computing device, a notification that the at least one characteristic is different from the one or more first characteristics.

In some aspects, the techniques described herein relate to a computer-implemented method, where the outputting further includes superimposing the at least one characteristic onto the video stream data in real time.

In some aspects, the techniques described herein relate to a computer-implemented method, where the outputting includes displaying, via a user interface, a notification that the at least one characteristic is different from the one or more first characteristics.

In some aspects, the techniques described herein relate to a computer-implemented method, further including transmitting, to the second computing device, a request for the at least one characteristic, where receiving the at least one characteristic is based on the request.

In some aspects, the techniques described herein relate to a computer-implemented method performed by a first computing device, the computer-implemented method including transmitting, to a second computing device, video stream data including a set of frames and audio data, where the video stream data is associated with one or more items and one or more first characteristics of the one or more items based on the one or more items being associated with vector representations that match respective vector representations of the set of frames within a threshold value, and where the respective vector representations of the set of frames are output from at least one learning model, and receiving, from the second computing device, the video stream data and at least one characteristic of the one or more items that is different from the one or more first characteristics.

In some aspects, the techniques described herein relate to a computer-implemented method, further including outputting a notification for display that the at least one characteristic is different from the one or more first characteristics, where the at least one characteristic is superimposed onto the video stream data in real time, and where at least one of the one or more first characteristics or the at least one characteristic include respective categories of the one or more items, respective physical attributes of the one or more items, or respective conditions of the one or more items.

### Examples of Environments

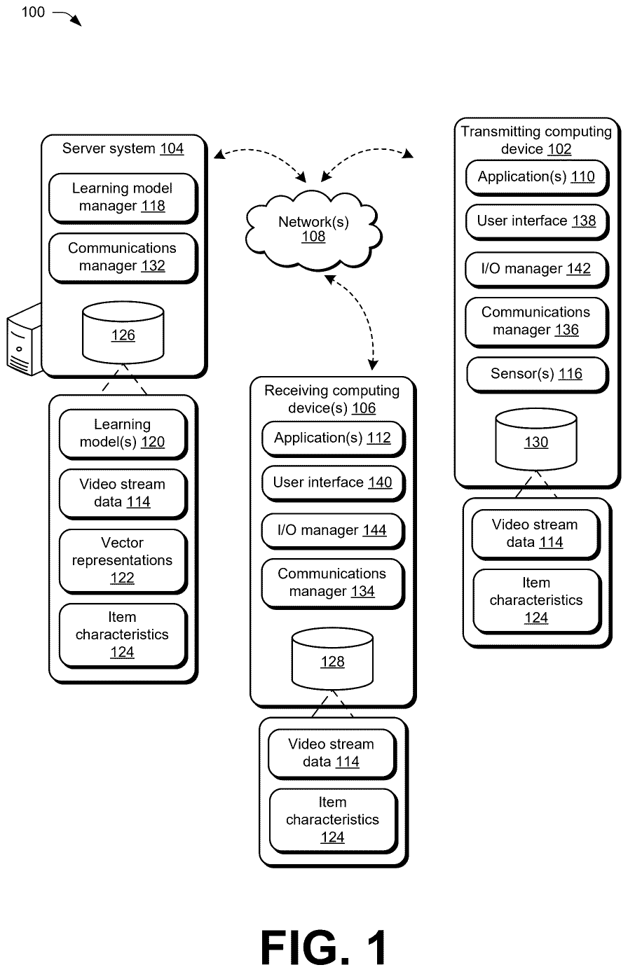

FIG. 1 is an illustration of an environment 100 in an example implementation that is operable to implement techniques described herein. The environment 100 includes a transmitting computing device 102, a server system 104, and one or more receiving computing devices 106. In one or more implementations, the transmitting computing device 102, the receiving computing devices 106, and/or the server system 104 may be communicatively coupled via one or more networks 108. For example, the server system 104 may communicatively couple the transmitting computing device 102 with the receiving computing devices 106 via the networks 108. Additionally, or alternatively, the transmitting computing device 102 and the receiving computing devices 106 may be communicatively coupled (e.g., directly, rather than indirectly through the server system 104). An example of the networks 108 is the Internet, although the transmitting computing device 102, the server system 104, and the receiving computing devices 106 may be communicatively coupled using one or more different connections or different networks 108 (e.g., wireless networks, cellular networks) in various implementations.

A server system 104 may include one or more devices, such as application servers, database servers, web servers, and file servers, among other examples, to manage different aspects of data processing and storage. The devices in the server system 104 may be referred to as server devices. In some examples, the transmitting computing device 102, the receiving computing devices 106, and the server devices in the server system 104 may exchange instructions, signaling, messages, or other communications via the networks 108 (e.g., a wireless connection, over the air) or via a wired connection (e.g., a physical connections). For example, the server devices may transmit signaling to the transmitting computing device 102 and/or the receiving computing devices 106 that includes instructions that cause the transmitting computing device 102 and/or the receiving computing devices 106 to perform one or more tasks or actions (display or output digital media content, display or output feedback, display or output notifications, transmit signaling, receive signaling, etc.). The transmitting computing device 102 and/or the receiving computing devices 106 may receive and decode the signaling and may perform the actions according to the instructions.

Although the server system 104 is depicted in the environment 100 as being separate from the transmitting computing device 102 and/or the receiving computing devices 106, in one or more implementations, an entirety, or various portions of the server system 104 may be implemented at or by the transmitting computing device 102 and/or the receiving computing devices 106. In at least one implementation, for example, at least a portion of the server system 104 may be implemented by one or more applications 110 of the transmitting computing device 102 and/or using various resources of the transmitting computing device 102, such as hardware resources, an operating system, firmware, and so forth. Additionally, or alternatively, at least a portion of the server system 104 may be implemented by one or more applications 112 of the receiving computing device 106 and/or using various resources of the receiving computing device 106, such as hardware resources, an operating system, firmware, and so forth. In some examples, the server system 104 may be implemented by server-based storage resources, processing resources, and so on of devices other than the transmitting computing device 102 and/or the receiving computing devices 106. For example, at least a portion of the server system 104 may be implemented using a third-party service, such as a web services platform that provides one or more hardware and/or other computing resources to support provision of services by web service providers. In variations, an entirety, or various portions of the server system 104 may be implemented at or by a device of the user (e.g., a mobile device, a laptop, a wearable device, or any other device).

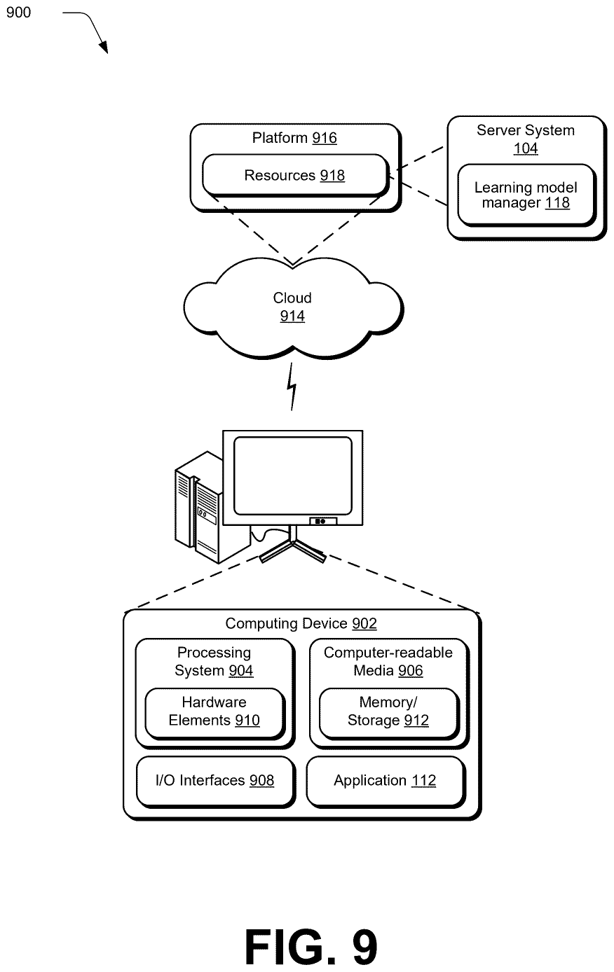

A transmitting computing device 102 and/or receiving computing devices 106 that implement the environment 100 are configurable in a variety of ways. A transmitting computing device 102 and/or a receiving computing device 106, for example, may be configurable as a desktop computer, a laptop computer, a mobile device (e.g., assuming a handheld configuration such as a tablet or mobile phone), an internet of things (IoT) device, a wearable device (e.g., a smart watch, a ring, or smart glasses), an augmented reality and/or virtual reality device (e.g., the smart glasses), a server, and so forth. Thus, a transmitting computing device 102 and/or a receiving computing device 106 may range from full resource devices with substantial memory and processor resources to low-resource devices with reduced memory and/or processing resources. Although in instances in the following discussion reference is made to a transmitting computing device 102 and/or a receiving computing devices 106 in the singular, a transmitting computing device 102 and/or a receiving computing device 106 may also be representative of multiple different devices, such as multiple servers of a server farm utilized to perform operations “over the cloud” as further described in relation to FIG. 9.

The transmitting computing device 102 and/or the receiving computing devices 106 may support various types or modes of communications, including, but not limited to, simplex communications, duplex communications, and full duplex communications. Simplex communications refers to a one-way transmission of data, such as from the transmitting computing device 102 or a receiving computing device 106 or to the transmitting computing device 102 or the receiving computing device 106. For simplex communications, data flows in a single direction, where the transmitting computing device 102 and the receiving computing device 106 do not transmit and receive at the respective devices concurrently. Duplex communications refers to a two-way communication system, where the transmitting computing device 102 and/or the receiving computing device 106 are capable of both transmitting and receiving data, but not concurrently. Full duplex communications may refer to a communication mode in which the transmitting computing device 102 and/or the receiving computing device 106 can transmit and receive data concurrently, providing for bidirectional exchange of the data between the respective devices.

The transmitting computing device 102 and/or the receiving computing device 106 may implement one or more web sockets to facilitate full duplex communication in real time or in near real time (e.g., with less than a threshold latency or delay for data exchange between the transmitting computing device 102 and the receiving computing device 106). A web socket may refer to a communication protocol that enables full duplex, bidirectional communication over a single transmission control protocol (TCP) connection between a client device and a server device. For example, the transmitting computing device 102 and one or more server devices at the server system 104 may use a web socket to exchange data. Additionally, or alternatively, the receiving computing devices 106 and the server devices at the server system 104 may use a web socket to exchange data.

The transmitting computing device 102 may provide one or more services to the receiving computing devices 106 and/or the server system 104. For example, the transmitting computing device 102, the receiving computing devices 106, and/or the server system 104 may implement or deploy one or more of the applications 110 and the application 112 to facilitate the display of video stream data 114. In some cases, the application 110 may be an example of or may include a same application as the application 112. The application 110 and the application 112 may be an example of an online marketplace application that facilitates the exchange of goods or services via the application 110 and the application 112. As part of the exchange of goods or services, the transmitting computing device 102 and/or the server system 104 can send the video stream data 114 to the receiving computing device 106, where the video stream data 114 includes or is representative of one or more items for sale via the online marketplace application. In some other cases, the application 110 may be a different version or instance of the application 112. For example, the application 110 may facilitate the listing and sale of one or more items, while the application 112 may facilitate the purchase of the items.

In at least one implementation, the application 110 and the application 112 may support communication of the video stream data 114 and/or additional data across the networks 108 between the transmitting computing device 102 and the receiving computing devices 106 (e.g., directly). In at least one other implementation, the application 110 and the application 112 may support communication of the video stream data 114 and/or additional data across the networks 108 between the transmitting computing device 102, the receiving computing device 106, and the server system 104 (e.g., instructions to cause the transmitting computing device 102 and/or the receiving computing device 106 to perform tasks or actions, including displaying the video stream data 114). One example of the application 110 and/or the application 112 is a browser or other web application that facilitates user interaction to capture and exchange the video stream data 114. Another example of the application 110 and/or the application 112 is a web-based computer application that facilitates user interaction to capture and exchange the video stream data 114, such as a mobile application or a desktop application. The application 110 may be configured in different ways, which provide for users to interact with the transmitting computing device 102 and by extension perform actions to capture (e.g., create, generate) the video stream data 114, broadcast (e.g., send, transmit, output) the video stream data 114, and receive user input related to the video stream data 114, without departing from the spirit or scope of the techniques described herein. The application 112 may be configured in different ways, which provide for users to interact with the receiving computing devices 106 and by extension perform actions to obtain (e.g., receive) the video stream data 114, display the video stream data 114, and receive user input related to the video stream data 114, without departing from the spirit or scope of the techniques described herein.

Video stream data 114 may refer to digital media content that includes a series of frames (e.g., a sequence of digital images that together represent motion of a subject of the digital images) and corresponding audio data transmitted in real-time or near real-time. The video stream data 114 may include a live video of items that are listed via the application 110 and/or the application 112 or are being transmitted for display at the receiving computing devices 106, including audio descriptions and commentary from the user of the transmitting computing device 102. The transmitting computing device 102 may generate, obtain, or capture the video stream data 114 using one or more sensors 116. The sensors 116 at the transmitting computing device 102 may include cameras, microphones, depth sensors, and other types of sensors capable of capturing information about items included in the video stream data 114. For example, a camera sensor can capture high-resolution images of products, while a depth sensor (e.g., a light detection and ranging (LiDAR) sensor) can detect the dimensions and spatial positioning of an item in the video stream data 114. The sensors 116 can capture (e.g., measure, collect, obtain) the video stream data 114, as well as spatial information, to define one or more items represented by or in the video stream data 114.

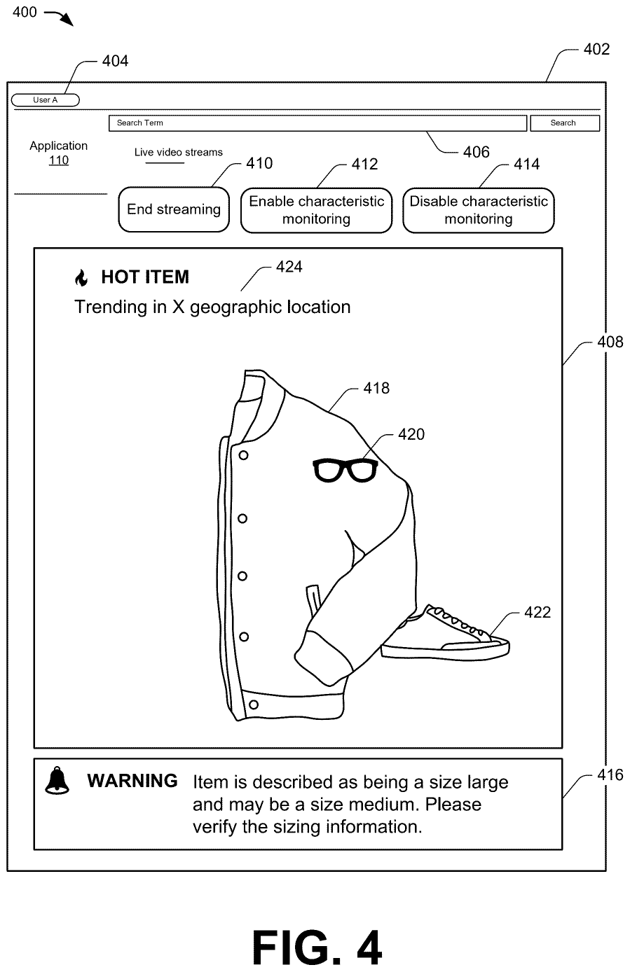

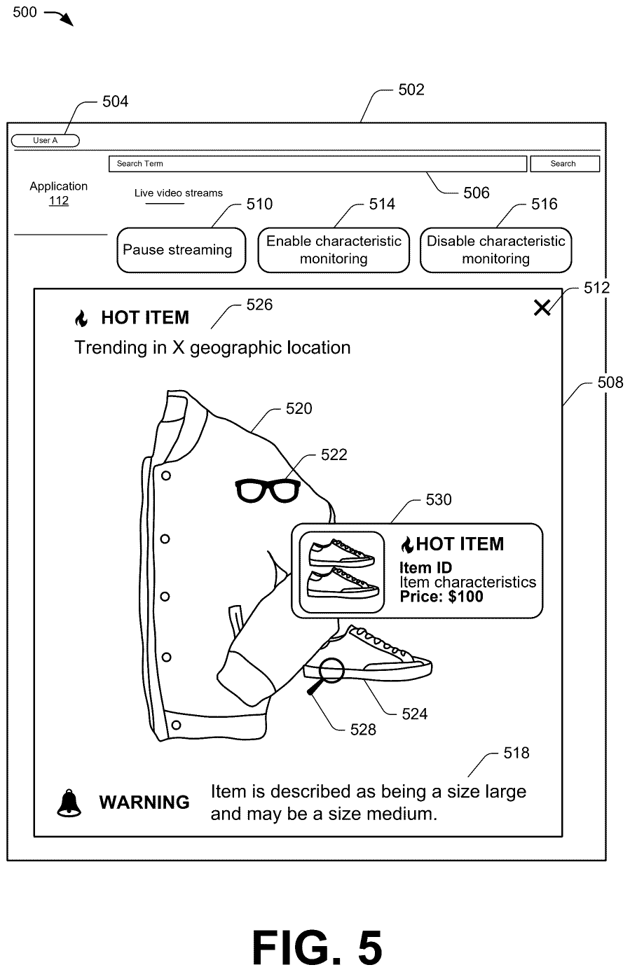

The transmitting computing device 102 transmits the video stream data 114 and the spatial information, if collected, to the server system 104 and/or to the receiving computing devices 106. The server system 104 and the receiving computing devices 106 can analyze the video stream data 114 and the spatial information captured by the sensors 116 of the transmitting computing device 102 to detect items and relative position of the items. The position of the items may be relative to a defined point in space, such as the sensor 116, or relative to one or more other items in the video stream data 114 (e.g., a background or foreground relative to an identified or defined item), which is described in further detail with respect to FIGS. 4 and 5.

In some examples, the server system 104 may implement a learning model manager 118 to process and analyze data (e.g., the video stream data 114, the spatial information). For example, the learning model manager 118 processes the video stream data 114 using one or more learning models 120, which may be examples of machine learning models or artificial intelligence models. The learning models 120 can generate vector representations 122 of respective frames of the video stream data 114. The vector representations 122 are numerical encodings of visual features of the respective frames, such as color, shape, texture, and spatial relationships, among other examples. Generating the vector representations 122 enables efficient similarity matching by reducing high-dimensional image data into compact mathematical representations that can be compared using distance metrics in a vector space (e.g., using fewer computational resources relative to comparing high-dimensional image data). The learning model manager 118 may use the vector representations 122 and the audio data of the video stream data 114 to determine whether the video stream data 114 includes accurate item characteristics 124. For example, the learning model manager 118 compares the vector representations 122 of the frames to historical (e.g., previously generated or defined) vector representations of one or more items to determine whether the vector representations 122 match the historical vector representations within a threshold value. If the vector representations 122 match within the threshold value, then the server system 104 determines that the video stream data 114 includes the items. The server system 104 can obtain one or more item characteristics 124 of the identified items from a data storage 126 and/or by parsing the audio data.

In some cases, the server system 104 can perform key frame detection on a defined numerical quantity of frames of the video stream data 114. Key frame detection can include identifying a subset of frames within a sequence of frames that include distinct visual information. Key frame detection reduces computational overhead (e.g., processing, memory, and power consumption) by analyzing frames that include visual changes, rather than processing the entire sequence of frames. After detecting the key frames, the server system 104 identifies one or more items in the key frames and obtains (e.g., detects, identifies, determines) one or more similar items to the items in the key frames. The server system 104 can obtain the similar items by generating vector representations 122 of the key frames and comparing the vector representations 122 of the key frames to an image index data storage (e.g., at the data storage 126) including vector representations of images listed at or related to the application 110 and/or the application 112.

In some examples, the server system 104 can train the learning models 120 on relatively large datasets (e.g., greater than a threshold numerical quantity of data samples in the datasets) of images of items, video data, descriptions of items, and vector representation data. The training process can include supervised learning, semi-supervised learning, and unsupervised learning (e.g., training) processes to enable the learning models 120 to accurately identify and classify various item characteristics 124. In supervised learning, the server system 104 may train the learning models 120 on labeled datasets, where item images are paired with corresponding vector representations and/or characteristics, such as a brand, a condition, or a size. For example, the server system 104 may use a dataset of clothing images labeled with respective sizes to train a model that can accurately estimate dimensions of clothes from video frames. Semi-supervised learning approaches may combine a smaller set of labeled data with a larger set of unlabeled data to improve a performance (e.g., precision, accuracy) of the learning model 120. For example, the server system 104 may use a defined numerical quantity of labeled product images and a relatively large set of unlabeled listings to train learning models 120 to detect subtle differences in item quality or authenticity. Unsupervised learning techniques may provide for the learning models 120 to detect patterns or groupings within unlabeled data. The server system 104 may use unsupervised learning to train a learning model 120 (e.g., a clustering algorithm) to automatically categorize items according to visual similarities, which can lead to identifying trends or contextually relevant information for the items.

In some examples, the server system 104 may implement the learning models 120 using one or more central processing units (CPUs) (e.g., rather than graphical processing units (GPUs)) to reduce the use of computational resources. For example, the server system 104 may implement the learning models 120 to detect inconsistencies in the video stream data 114, such as by performing the described item detection techniques and/or by performing automatic speech recognition on the audio data of the video stream data 114. The server system 104 may perform automatic speech recognition to detect by parsing and analyzing the audio content of the video stream data 114. For example, the server system 104 may convert the audio data into text. The server system 104 processes the text using a learning model 120, such as a natural language processing model, to identify (e.g., extract, determine, obtain, detect) item characteristics 124 in the text. The natural language processing model may be an example of a large language model (LLM) that has been fine-tuned (e.g., trained) on datasets related to item descriptions. For example, the learning model 120 may determine that text values “barely used” or “like new” relate to a condition of an item, while the text values “runs small” or “fits like a glove” relate to sizing characteristics of the item. The server system 104 can compare the identified item characteristics 124 in the text to the visually detected characteristics and characteristics identified from metadata for the item to identify inconsistencies in the item characteristics 124 and/or to determine additional relevant contextual information related to the items.

Item characteristics 124 may refer to one or more features, attributes, or properties of the items included in or represented by the video stream data 114. The item characteristics 124 may include, but are not limited to, physical attributes (e.g., size, color, or condition), as well as other relevant information (e.g., brand, model number, or price). For example, the item characteristics 124 for a smartphone may include a screen size, storage capacity, camera specifications, and current market value. The server system 104 can access a data storage 126 to obtain metadata for a defined numerical quantity of similar items (e.g., 100 similar items) that indicates the characteristics of the similar items. The server system 104 can compare the characteristics of the similar items obtained from the metadata to the item characteristics 124 (e.g., identified from the analysis of the frames, spatial information, and/or audio data) and can determine whether the item characteristics 124 and/or the characteristics of the similar items are different (e.g., do not match within a threshold).

The server system 104 can identify inconsistencies (e.g., discrepancies, errors) in the item characteristics 124 by comparing the item characteristics 124 detected in the frames by the learning models 120 to the item characteristics 124 detected in the audio data by the learning models 120. For example, if the audio data includes a description of a jacket as “brand new,” but the learning model detects signs of wear, then the server system 104 can flag the inconsistency. The server system 104 can transmit an indication of one or more item characteristics 124 that are flagged as inconsistent to the transmitting computing device 102 and/or to the receiving computing devices 106. The server system 104 can transmit the video stream data 114 to the receiving computing devices 106, as well as instructions to display the indication of the item characteristics 124 that are flagged. The receiving computing devices 106 can superimpose (e.g., overlay) the indication of the item characteristics 124 that are flagged over the video stream data 114 in real time or in near real time (e.g., with less than a threshold latency or delay between transmitting the video stream data 114 from the transmitting computing device 102 to the receiving computing device 106, 6 seconds or less), which is described in further detail with respect to FIGS. 4 and 5. The indication can include a text value or other notification, such as “Condition may differ from description” or “Signs of wear detected.” The server system 104 can send the indication of the item characteristics 124 that are flagged (e.g., corrected information) to both the transmitting computing device 102 and the receiving computing devices for display at both devices.

In some examples, the server system 104 can implement the learning models 120 to analyze metadata and user behavior data to detect trends and patterns relevant to the items, referred to as relevant contextual information. For example, by analyzing purchase history and user engagement data, the learning models 120 can detect that an item is trending for a user category. The server system 104 may periodically obtain updated metadata and/or user behavior data and can store the data at the data storage 126. The server system 104 can transmit the relevant contextual information to be displayed with the video stream data 114, such as by displaying a notification “Popular among users in your area” or “Frequently purchased with Item X.”

The data storage 126, the data storage 128, and the data storage 130 at the server system 104, the receiving computing devices 106, and the transmitting computing device 102, respectively, can store relevant data. For example, the server system 104 can store databases of product information and user data at the data storage 126. The transmitting computing device 102 can store locally captured sensor data (e.g., the video stream data 114), as well as item characteristics 124 received in an indication from the server system 104 at the data storage 130. The receiving computing devices 106 can store received data, such as the video stream data 114 and the item characteristic 124, as well as user data at the data storage 128. The data storage 126, the data storage 128, and the data storage 130 may represent one or more databases and/or other types of storage capable of storing the relevant data. Examples may include, but are not limited to, mass storage and virtual storage. In one or more implementations, for example, the data storage 126, the data storage 128, and the data storage 130 may be virtualized across multiple data centers and/or cloud-based storage devices.

In some examples, the data storage 126 may be an example of a knowledge graph, including an enterprise knowledge graph. A knowledge graph is a structured representation of interconnected information stored in the data storage 126, capturing complex relationships between various elements of the server system 104. The graph-based data structure organizes and links different types of information, including item characteristics 124, digital media content, and analytics data. The knowledge graph serves as a comprehensive repository of latent information, connecting details about products, user behaviors, and market trends. For example, an enterprise knowledge graph for the server system 104 may include nodes representing individual products, attributes, categories, and related media content, with edges denoting relationships, such as similarity, complementarity, or historical co-purchases. The ontology within the graph may include hierarchies of item categories, buyer preference profiles, and user behavior patterns. By encoding the relationships, the knowledge graph enables efficient querying and inference, providing for the server system 104 to extract relevant contextual information for video generation tasks. For example, the knowledge graph may enable the server system 104 to identify trending items within a defined category or suggest visually similar products, among other examples.

The communications manager 132, the communications manager 134, and the communications manager 136 at the server system 104, the receiving computing devices 106, and the transmitting computing device 102, respectively, can support the exchange of data between devices. For example, the communications manager 132, the communications manager 134, and the communications manager 136 manage the exchange (e.g., transmission and reception) of video stream data 114, item characteristics 124, and any additional contextual information or alerts generated by the server system 104.

The user interface 138 and the user interface 140 at the transmitting computing devices 102 and the receiving computing device 106, respectively, provide the visual and interactive elements through which users interact with the application 110 and the application 112. For example, the user interface 138 can include controls or interactive elements for starting and stopping collection and/or broadcasting of the video stream data 114. The user interface 140 can include one or more controls or interactive elements for interacting with the video stream data 114, such as tapping on items to see more details. The user interface 138 and the user interface 140 support user input, such as a long press on the screen or a short press on the screen (e.g., greater than or less than a threshold duration of input), to cause the user interface 138 and the user interface 140 to display various information, including metadata for items in the video stream data 114.

The I/O manager 142 and the I/O manager 144 at the transmitting computing devices 102 and the receiving computing device 106, respectively, provide for input and output operations, including managing user interactions with the user interface 138 and the user interface 140, processing voice commands, or controlling the display output of the video stream data 114 and associated information. The I/O manager 142 and the I/O manager 144 support two-dimensional display of the video stream data 114, as well as three-dimensional display of the video stream data 114. For example, the I/O manager 142 and the I/O manager 144 can output the video stream data 114 and/or related information in at an augmented reality and/or virtual reality device. Examples of user input may include, but are not limited to, receiving touch input in relation to portions of a displayed user interface, receiving one or more voice commands, receiving typed input, receiving mouse or stylus input, and so forth.

In some examples, the processes described as being performed by the server system 104 may additionally, or alternatively, be performed by the receiving computing devices 106 and/or the transmitting computing device 102. For example, a receiving computing device 106 can implement a learning model manager 118 to detect inconsistencies or discrepancies in item characteristics 124 from video stream data 114 and/or can identify relevant contextual information. The receiving computing devices 106 and/or the transmitting computing device 102 can implement one or more learning models 120 according to one or more capabilities (e.g., processing power and memory capabilities). The receiving computing devices 106 and/or the transmitting computing device 102 implementing the learning models 120 can reduce latency and enable real-time analysis of the video stream data 114 (e.g., even with reduced network connectivity to the networks 108).

By implementing learning models 120 to generate vector representations 122 of frames to use for identifying inconsistent item characteristics 124 in video stream data 114, a server system 104 reduces computational resource consumption compared with conventional techniques that process image data without converting the image data to the vector representations 122. Further, the server system 104 implementing learning models 120 to identify contextually relevant information for items in the video stream data 114 reduces network bandwidth use, as well as computational resources (e.g., processing, memory, power) by proactively identifying and transmitting the relevant information, rather than entire contextual datasets.

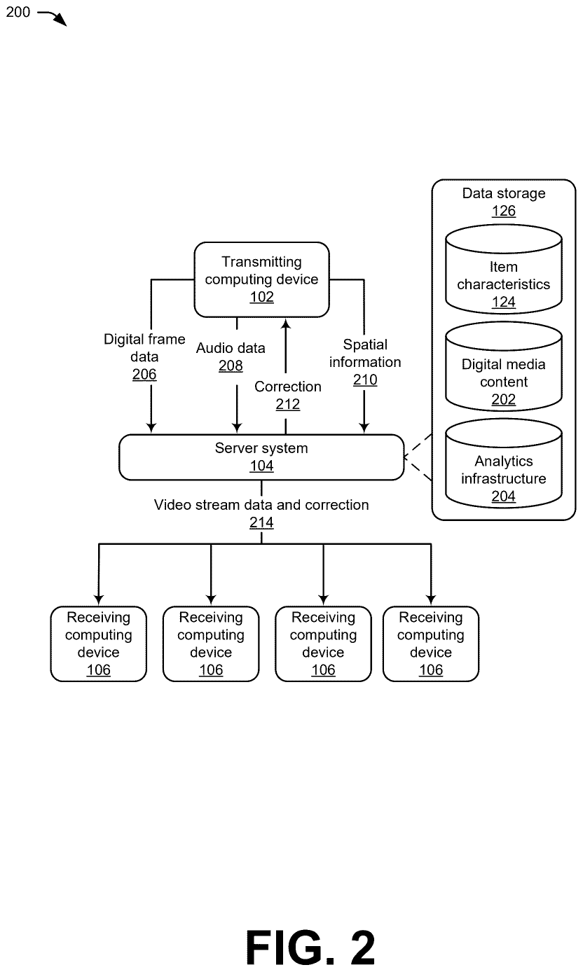

FIG. 2 depicts an environment 200 in an example implementation that is operable to employ techniques described herein. The environment 200 may implement, or be implemented by, aspects of FIG. 1. For example, the environment 200 may include a transmitting computing device 102, a server system 104, and receiving computing devices 106, which may be examples of the corresponding devices as described with reference to FIG. 1.

The transmitting computing device 102 may be a device that is transmitting (e.g., sending, broadcasting, outputting) digital media content, such as the video stream data, to one or more receiving computing devices 106. The receiving computing devices 106 are the targets for displaying the video stream data. The transmitting computing device 102 may transmit the video stream data directly to the receiving computing devices 106 or may transmit the video stream data to the receiving computing devices 106 via the server system 104. The server system 104 and/or the receiving computing devices 106 may process the video stream data to detect any inconsistencies in the video stream data, as described with reference to FIG. 2. The receiving computing devices 106 can display the video stream data and an indication of the inconsistencies, as well as any relevant contextual information.

The server system 104 can include data storage 126, which may be an example of the data storage 126, as described with reference to FIG. 1. For example, the data storage 126 may be an example of a knowledge graph, such as an enterprise knowledge graph. The data storage 126 can include respective databases to store item characteristics 124 (e.g., the item characteristics 124, as described with reference to FIG. 1), digital media content 202, and analytics infrastructure 204. Digital media content 202 may refer to various forms of digital content related to items, such as images (e.g., an image index database), videos, or textual descriptions of products listed at an online marketplace application, among other examples. Analytics infrastructure 204 can include learning models (e.g., weights, biases, and other parameters that define the learning models) and data for analyzing user behavior, market trends, and item performance, which may include purchase history, search patterns, or popularity metrics for items.

The transmitting computing device 102 obtains and transmits digital frame data 206, audio data 208, and spatial information 210 to the server system 104. Digital frame data 206 includes one or more individual images (e.g., frames) in a sequence that make up a video stream, including capturing visual details of items. The audio data 208 includes spoken descriptions, commentary, or background sounds accompanying the video stream, which may include verbal item characteristics or contextual information related to the items in the digital frame data 206. The transmitting computing device 102 can capture (e.g., measure, obtain) the spatial information 210 using one or more sensors, such as depth sensors or other hardware, providing three-dimensional data about a size of the items, a shape of the items, other physical characteristics of the items, and position relative to the camera or other items in the digital frame data 206.

The server system 104 can identify inconsistencies in item characteristics 124 by comparing the information from the different data sources (e.g., the digital frame data 206, the audio data 208, and/or the spatial information 210) to each other and against stored item data. For example, if the audio description describes an item as being “brand new” but the visual data shows signs of wear, then the server system 104 flags a condition characteristic of the item as an inconsistency. Based on the analyses, the server system 104 generates a correction 212, which may include an indication of the inconsistencies detected and recommendations for accurate item descriptions. The server system 104 can send the correction 212 back to the transmitting computing device 102 to notify (e.g., alert) the user of the transmitting computing device 102 of the discrepancy. Additionally, or alternatively, the server system 104 can forward the video stream data and correction 214 to the receiving computing devices 106, providing for the receiving computing devices 106 to display the video stream data and correction to notify a user of the receiving computing devices 106 of the discrepancy.

Having considered examples of environments, consider now a discussion of some example details of the techniques for monitoring item characteristics from video stream data using a knowledge graph in accordance with one or more implementations.

### Monitoring Item Characteristics From Video Stream Data

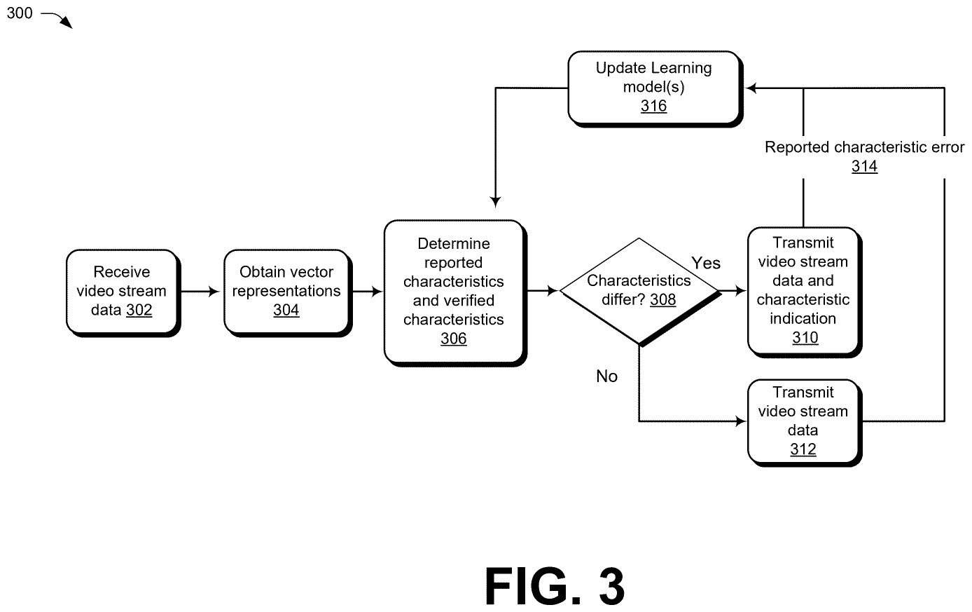

FIG. 3 depicts a procedure 300 for monitoring item characteristics from video stream data using a knowledge graph. The procedure 300 may implement, or be implemented by, aspects of FIGS. 1 and 2. For example, the procedure 300 may be implemented by a server system and/or a receiving computing device, such as the server system 104 and the receiving computing devices 106 as described with reference to FIGS. 1 and 2.

At 302, video stream data is received. For example, a server system or receiving computing device may receive video stream data from a transmitting computing device. The video stream data includes a set of frames and audio data. The frames may be digital images that capture visual details of one or more items, while the audio data can include spoken descriptions or commentary about the items.

At 304, vector representations of the frames are obtained. The server system or receiving computing device may provide the frames as input to at least one learning model and obtain respective vector representations of the frames as output. The vector representations are numerical encodings of visual features that enable efficient similarity matching.

At 306, reported characteristics and verified characteristics are determined. For example, the server system or the receiving computing device may detect one or more items and corresponding characteristics of the items by comparing the vector representations to stored vector representations of known items. The server system may also store characteristics and/or metadata of the known items. Thus, if the items match within a threshold to known items, then the server system can determine one or more verified characteristics of the items from the stored characteristics and/or the metadata. Additionally, or alternatively, the server system can infer one or more characteristics (physical characteristics, such as size, color, shape, etc.) of the items from the frames of the video stream data and/or from spatial information provided by a transmitting computing device. The server system or the receiving computing device can determine one or more reported characteristics by analyzing the audio data to detect characteristics identified in the audio data.

At 308, a determination is made as to whether the reported characteristics and the verified characteristics differ. For example, the server system or the receiving computing device can compare the identified characteristics from the frames to the identified characteristics from the audio data to detect discrepancies (e.g., inconsistencies).

At 310, if the characteristics differ (e.g., “Yes” at 308), then the video stream data and the differing characteristic indication are transmitted. The server system may send the video stream data and the indication of the differing characteristics to one or more receiving computing devices for display. At 312, if the characteristics do not differ (e.g., “No” at 308), then the video stream data is transmitted to the receiving computing devices. For example, the server system forwards the video stream data to the receiving computing devices.

At 314, a reported characteristic error may be generated based on feedback from the receiving computing devices or the transmitting computing device. This feedback can indicate whether the identified inconsistencies were correctly flagged.

At 316, one or more learning models are updated (e.g., fine-tuned) using the reported characteristic error and other collected data. The continuous learning process enhances the ability of the server system and/or the receiving computing device to detect inconsistencies and provide relevant contextual information in future video stream data. For example, the iterative process provides for the learning models to adapt to new patterns and improve accuracy and precision over time based on real-world feedback from users and devices involved in the video streaming process.

FIG. 4 depicts an example of a user interface 400 for monitoring item characteristics from video stream data using a knowledge graph. The user interface 400 may implement, or be implemented by, aspects of FIGS. 1, 2, and 3. For example, the user interface 400 may be implemented by a transmitting computing device, such as the transmitting computing device 102 as described with reference to FIGS. 1 and 2.

The user interface 400 includes a display 402 at a transmitting computing device. The display 402 can include a user identifier 404 of an account of a user of the transmitting computing device 102. Respective user accounts can have associated account settings and user data (e.g., demographic information of the user and a geographic location of the user, among other examples). The display 402 can include a search tool 406 that provides for the user of the transmitting computing device to input search queries or keywords. The search tool 406 may include a text input field and a search button or icon. Users can use the search tool 406 to find items and/or categories for an application 110, which may be an example of the application 110 (e.g., an online marketplace application), as described with reference to FIG. 1.

The display 402 includes a video streaming window 408 that includes live video content of items, including the video stream data. The display 402 includes one or more interactive elements, including an interactive element 410 labeled with “End streaming” to terminate broadcasting of video streaming data, an interactive element 412 labeled with “Enable characteristic monitoring” to activate characteristic inconsistency evaluation, and an interactive element 414 labeled with “Disable characteristic monitoring” to deactivate the characteristics inconsistency evaluation. If the interactive element 412 is selected, then the transmitting computing device can indicate to the server system to analyze the video stream data using learning models to detect potential inconsistencies between reported and verified item characteristics, as described with reference to FIGS. 1 through 3. The transmitting computing device can display an indication of the detected inconsistencies at a notification window 416 of the display 402. If the interactive element 414 is selected, then the transmitting computing device can indicate to the server system to suspend (e.g., cancel, terminate, pause) the analysis of the video stream data to detect inconsistencies.

The video streaming window 408 can display various items, including an item 418, which may be an item of interest, or a target item described in the video stream data, a foreground item 420, and a background item 422. The transmitting computing device and/or a server system can distinguish between the items based on a spatial positioning of the items within the frame, such as by using depth information captured by sensors at the transmitting computing device. In some cases, the transmitting computing device can display relevant contextual information 424. For example, the transmitting computing device can display a text value “HOT ITEM Trending in X geographic location” above the displayed items, providing real-time trend information to the user. The server system and/or a receiving computing device can determine the relevant contextual information 424 by analyzing purchase history, search patterns, and regional popularity metrics to identify trending items. For example, if the jacket being displayed has received an increase in search queries or purchases within the past 24 hours in a defined geographic region, then the transmitting computing device and/or a receiving computing device automatically displays the trend information.

In some examples, the notification window 416 may be separate from the video streaming window 408. In some other examples, a notification can be superimposed or can overlay the video streaming window 408. The notification can include a text value that indicates the inconsistency identified between characteristics in the video stream data. For example, the notification may indicate “Item is described as size large and may be size medium. Please verify the sizing information.”

In some cases, a methodology used for rendering the notification (e.g., statistic, information, metrics) can include performing an opacity adjusted overlay at an hypertext transfer protocol (HTTP) client using a hypertext markup language (HTML)-rendering engine. For example, the HTML-rendering engine processes incoming data and generates overlays that can be seamlessly integrated with the live video content, adjusting opacity to provide for readability, while maintaining visibility of an underlying video. If a user of the transmitting computing device begins describing a unique item (e.g., not a sports broadcasting event), then one or more graphical overlays appear at a receiving computing device, rather than being codec updated at the live video stream from the transmitting computing device. In some cases, codec updates may include modifying the video data at the transmitting computing device.

The user interface 400 may include functionality for the user of the transmitting computing device to provide feedback on the accuracy of the detected inconsistencies. The feedback mechanism can include an interactive element, such as a button, which provides for the user to confirm or reject the detected inconsistency. The transmitting computing device can send the feedback to the server system for updating the learning models, as described with reference to FIG. 3.

The characteristics monitoring process occurs in real-time as the video is being streamed (e.g., with less than a threshold delay caused by the characteristics monitoring process), providing for real-time detection and notification of inconsistencies between the reported and verified characteristics of the items. The server system and/or the receiving device may monitor multiple characteristics concurrently, including but not limited to size, color accuracy, condition (e.g., new vs. used), material composition, and authenticity markers. For example, if the audio data includes a description of the jacket (e.g., the item 418) as “100% genuine leather,” but the visual analysis of the texture and appearance suggests synthetic materials, then the server system and/or the receiving computing device can flag the inconsistency for verification. Additionally, or alternatively, the server system or the receiving device may detect signs of wear or damage that contradict a “brand new” description, such as faded areas, loose threads, or scuff marks that might not be visible to a viewer of the video streaming data but are detected through the image analysis capabilities of the learning models.

FIG. 5 depicts an example of a user interface 500 for monitoring item characteristics from video stream data using a knowledge graph. The user interface 500 may implement, or be implemented by, aspects of FIGS. 1, 2, 3, and 4. For example, the user interface 500 may be implemented by a receiving computing device, such as the receiving computing device 106 as described with reference to FIGS. 1 and 2.

The user interface 500 includes a display 502 at a receiving computing device. The display 502 can include a user identifier 504 of an account of a user of the receiving computing device. Respective user accounts can have associated account settings and user data (e.g., demographic information of the user and a geographic location of the user, among other examples). The display 502 can include a search tool 506 that provides for the user of the receiving computing device to input search queries or keywords. The search tool 506 may include a text input field and a search button or icon. Users can use the search tool 506 to find items and/or categories for an application 112, which may be an example of the application 112 (e.g., an online marketplace application), as described with reference to FIG. 1.

The display 502 includes a video streaming window 508 that includes live video content of items, including the video stream data. The display 502 includes one or more interactive elements, including an interactive element 510 labeled with “Pause streaming” to temporarily pause playback of the video streaming data and an interactive element 512 to terminate playback of the video streaming data by closing the video streaming window 508. The display 502 includes an interactive element 514 labeled with “Enable characteristic monitoring” to activate characteristic inconsistency evaluation and an interactive element 516 labeled with “Disable characteristic monitoring” to deactivate the characteristics inconsistency evaluation. If the interactive element 514 is selected, then the receiving computing device and/or a server system can analyze the video stream data using learning models to detect potential inconsistencies between reported and verified item characteristics, as described with reference to FIGS. 1 through 3. The receiving computing device can display an indication of the detected inconsistencies as a notification 518 of the display 502. If the interactive element 514 is selected, then the receiving computing device and/or the server system can suspend (e.g., cancel, terminate, pause) the analysis of the video stream data to detect inconsistencies.

The video streaming window 508 can display various items, including an item 520, which may be an item of interest, or a target item described in the video stream data, a foreground item 522, and a background item 524. The server system and/or the receiving device can identify and monitor characteristics of multiple items concurrently (e.g., simultaneously) within a same video frame. The receiving computing device and/or a server system can distinguish between the items based on a spatial positioning of the items within the frame, such as by using depth information captured by sensors at the transmitting computing device. In some cases, the receiving computing device can display relevant contextual information 526. For example, the receiving computing device can display a text value “HOT ITEM Trending in X geographic location” above the displayed items, providing real-time trend information to the user. The server system and/or the receiving computing device can determine the relevant contextual information 526 by analyzing purchase history, search patterns, and regional popularity metrics to identify trending items. For example, if the jacket being displayed (e.g., the item 520) has received an increase in search queries or purchases within the past 24 hours in a defined geographic region, then the receiving computing device automatically displays the trend information.

In some examples, the receiving computing device displays the notification 518 separate from the video streaming window 508 (e.g., in a separate window). In some other examples, the receiving computing device superimposes or overlays the notification 518 over the video streaming window 508. For example, the receiving computing device can superimpose the notification 518 over the video streaming window 508 using a semi-transparent overlay that appears at the bottom of the video streaming window 508, providing for users to see both the video stream data (e.g., the items) and the notification 518 concurrently. In some cases, the notification 518 can fade in and out or slide up from the bottom of the video streaming window 508, drawing attention to the inconsistency while minimizing disruption to the video stream data. The notification 518 can include a text value that indicates the inconsistency identified between characteristics in the video stream data. For example, the notification may indicate “Item is described as size large and may be size medium. Please verify the sizing information.”

The display 502 can include an interactive element 528 for obtaining additional information about one or more items in the video streaming window 508. For example, the interactive element 528, when hovered over or selected for an item, can indicate to the receiving computing device to display an item information window 530 within the video streaming window 508. The item information window 530 can display one or more characteristics related to an item (e.g., the item 520, the foreground item 522, and/or the background item 524). For example, the item information window 530 can include one or more text values that indicate relevant contextual information (e.g., “HOT ITEM,”) and/or characteristics of the item, such as an “Item ID,” “Item characteristics,” and “Price: $100.” The interactable element 528 may also provide for a user to obtain spatial information related to the items, such as dimensions or relative positioning, captured by sensors at the transmitting computing device.

The user interface 500 may include functionality for the user of the receiving computing device to provide feedback on the accuracy of the detected inconsistencies. The feedback mechanism can include an interactive element, such as a button, which provides for the user to confirm or reject the detected inconsistency. The receiving computing device can send the feedback to the server system for updating the learning models, as described with reference to FIG. 3.

The characteristics monitoring process occurs in real-time as the video is being streamed (e.g., with less than a threshold delay caused by the characteristics monitoring process), providing for real-time detection and notification of inconsistencies between the reported and verified characteristics of the items. The server system and/or the receiving device may monitor multiple characteristics concurrently, including but not limited to size, color accuracy, condition (e.g., new vs. used), material composition, and authenticity markers. For example, if the audio data verbally describes the jacket (e.g., the item 520) as “100% genuine leather,” but the visual analysis of the texture and appearance suggests synthetic materials, then the server system and/or the receiving computing device can flag the inconsistency for verification. Additionally, or alternatively, the server system or the receiving device may detect signs of wear or damage that contradict a “brand new” description, such as faded areas, loose threads, or scuff marks that might not be visible to a viewer of the video streaming data but are detected through the image analysis capabilities of the learning models.

### Example Procedures

This section describes examples of procedures for monitoring item characteristics from video stream data using a knowledge graph. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

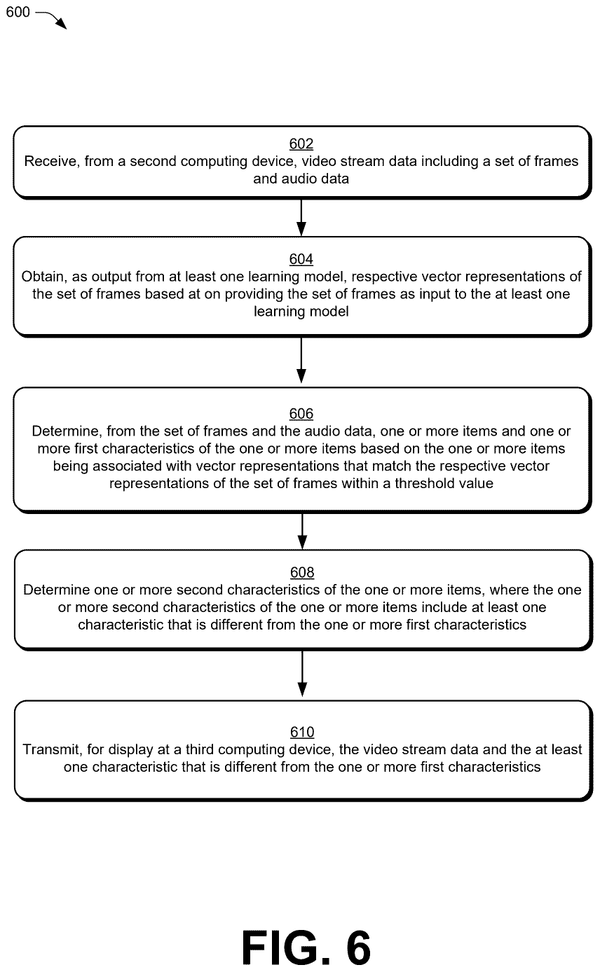

FIG. 6 depicts a procedure 600 in an example implementation of monitoring item characteristics from video stream data using a knowledge graph. The procedure 600 may be implemented by, or may implement, aspects of FIGS. 1 through 5. For example, the procedure 600 may be implemented by a server system (e.g., by one or more server devices of the server system), which may be an example of a server system 104, as described with reference to FIGS. 1 and 2. The procedure 600 is an example procedure 600 for managing inconsistencies in item characteristics from video stream data.

At 602, video stream data including a set of frames and audio data is received from a transmitting computing device. For example, the server system receives the video stream data (e.g., and optionally spatial information) from the transmitting computing device. The video stream data may include a live video of items being presented via an application.

At 604, respective vector representations of the set of frames are obtained as output from at least one learning model. For example, the server system provides the set of frames as input to the at least one learning model and receives the vector representations as output from the learning model. In some cases, the server system may perform key frame detection and may provide a subset of the set of frames as input to the learning model. The vector representations may include numerical encodings of visual features that enable efficient similarity matching (e.g., reduced latency).

At 606, one or more items and one or more first characteristics of the items are determined from the set of frames and the audio data. For example, the server system can determine the first characteristics based on the items being associated with vector representations (e.g., known, or historical vector representations) that match the respective vector representations of the set of frames within a threshold value. In some examples, the server system determines the first characteristics by parsing the audio data to extract item descriptions or details.

At 608, one or more second characteristics of the items are determined. The second characteristics can include at least one characteristic that is different from the one or more first characteristics. In some cases, the server system obtains an indication of one or more additional items within a threshold similarity to the identified items as output from an additional learning model, then retrieves metadata for the additional items to derive the second characteristics. Additionally, or alternatively, the server system uses an additional learning model to determine the second characteristics based on the identified items and user information associated with the transmitting computing device, taking into account trend data corresponding to the user information. Additionally, or alternatively, the server system receives sensor data (e.g., spatial information) from the transmitting computing device that directly indicates the second characteristics.

At 610, the video stream data and the at least one characteristic that differs from the first characteristics are transmitted for display at a receiving computing device. For example, the server system can transmit instructions to the receiving computing device to cause the receiving computing device to superimpose the differing characteristic onto the video stream data in real time or display a notification about the difference.

In some cases, the server system transmits a notification to the transmitting computing device that indicates the characteristic difference. The receiving computing device may send a request to the server system for the differing characteristic, with the transmission being based on the request. The characteristics may include, but are not limited to, categories, physical attributes, or conditions of the items.

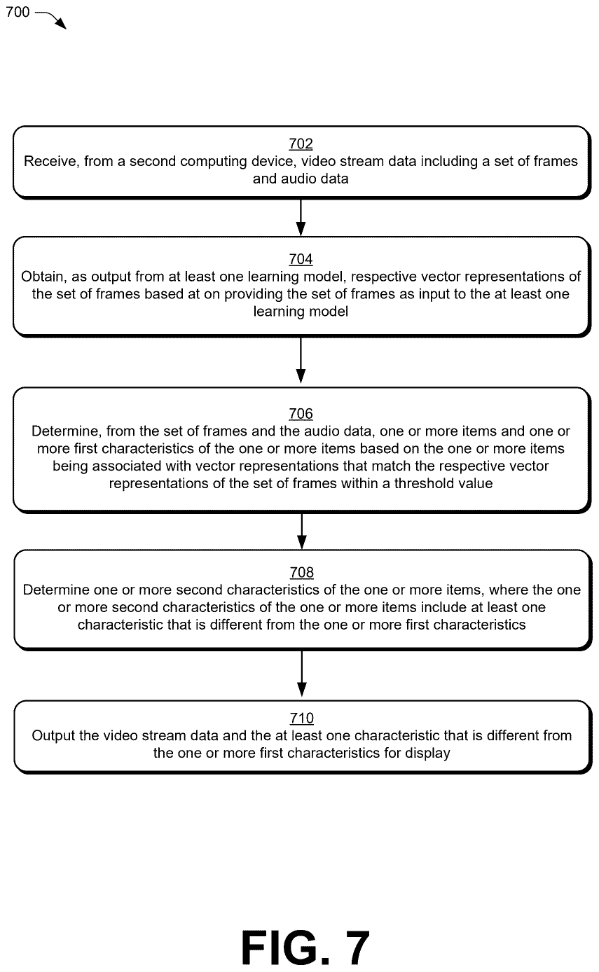

FIG. 7 depicts a procedure 700 in an example implementation of monitoring item characteristics from video stream data using a knowledge graph. The procedure 700 may be implemented by, or may implement, aspects of FIGS. 1 through 6. For example, the procedure 700 may be implemented by a receiving computing device, which may be an example of a receiving computing device 106, as described with reference to FIGS. 1 and 2. The procedure 600 is an example procedure 600 for managing inconsistencies in item characteristics from video stream data.

At 702, video stream data including a set of frames and audio data is received from a transmitting computing device. For example, the receiving computing device receives the video stream data (e.g., and optionally spatial information) from the transmitting computing device. The video stream data may include a live video of items being presented via an application.

At 704, respective vector representations of the set of frames are obtained as output from at least one learning model. For example, the receiving computing device provides the set of frames as input to the at least one learning model and receives the vector representations as output from the learning model. In some cases, the receiving computing device may perform key frame detection and may provide a subset of the set of frames as input to the learning model. The vector representations may include numerical encodings of visual features that enable efficient similarity matching (e.g., reduced latency).

At 706, one or more items and one or more first characteristics of the items are determined from the set of frames and the audio data. For example, the receiving computing device can determine the first characteristics based on the items being associated with vector representations (e.g., known, or historical vector representations) that match the respective vector representations of the set of frames within a threshold value. In some examples, the receiving computing device determines the first characteristics by parsing the audio data to extract item descriptions or details.

At 708, one or more second characteristics of the items are determined. The second characteristics can include at least one characteristic that is different from the one or more first characteristics. In some cases, the receiving computing device obtains an indication of one or more additional items within a threshold similarity to the identified items as output from an additional learning model, then retrieves metadata for the additional items to derive the second characteristics. Additionally, or alternatively, the receiving computing device uses an additional learning model to determine the second characteristics based on the identified items and user information associated with the transmitting computing device, taking into account trend data corresponding to the user information. Additionally, or alternatively, the receiving computing device receives sensor data (e.g., spatial information) from the transmitting computing device that directly indicates the second characteristics.

At 710, the receiving computing device outputs the video stream data and the differing characteristics for display. For example, the receiving computing device superimposes the characteristic onto the video in real time and/or displays a notification about the difference via a user interface, as described with reference to FIG. 5. In some examples, the receiving computing device can transmit a notification that indicates the difference in characteristics to the transmitting computing device. In some cases, the receiving computing device can transmit a request to the server system (e.g., a server device of the server system) and/or to the transmitting computing device for the differing characteristic.

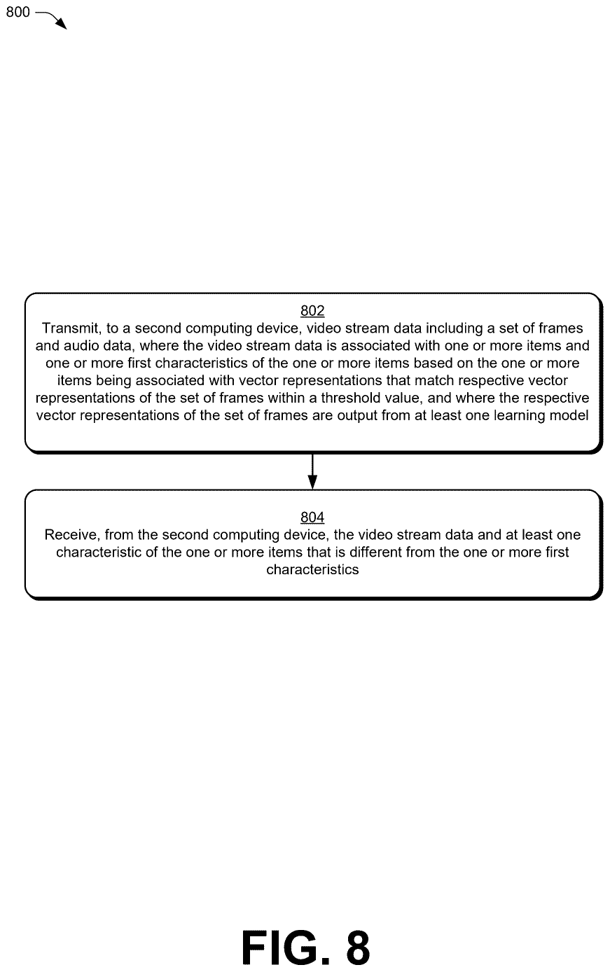

FIG. 8 depicts a procedure 800 in an example implementation of monitoring item characteristics from video stream data using a knowledge graph. The procedure 800 may be implemented by, or may implement, aspects of FIGS. 1 through 7. For example, the procedure 800 may be implemented by a transmitting computing device, which may be an example of a transmitting computing device 102, as described with reference to FIGS. 1 and 2. The procedure 800 is an example procedure 800 for managing inconsistencies in item characteristics from video stream data.

At 802, a transmitting computing device transmits video stream data including a set of frames and audio data to a receiving computing device and/or to a server device in a server system. The video stream data is associated with one or more items and one or more first characteristics of the items. The association is based on the items having vector representations that match respective vector representations of the set of frames within a threshold value. The respective vector representations of the frames are output from at least one learning model.

At 804, the transmitting computing device receives the video stream data and at least one characteristic of the items from the receiving computing device and/or the server device. The received characteristic is different from the one or more first characteristics initially associated with the items. For example, the receiving computing device and/or the server device may perform analysis on the video stream data to detect discrepancies or additional information about the items.

The transmitting computing device can output a notification for display that the at least one characteristic is different from the one or more first characteristics. The notification can be superimposed onto the video stream data in real time, as described with reference to FIG. 4. The characteristics may include, but are not limited to, respective categories of the items, physical attributes of the items, or conditions of the items.

Having described examples of procedures in accordance with one or more implementations, consider now an example of a system and device that can be utilized to implement the various techniques described herein.

### Example System and Device

FIG. 9 illustrates an example of a system generally at 900 that includes an example of a computing device 902 that is representative of one or more computing systems and/or devices that may implement the various techniques described herein. This is illustrated through inclusion of the application 112 if the computing device is a receiving computing device (e.g., or the application 110 if the computing device is a transmitting computing device), the server system 104, and the learning model manager 118. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that may be configured as processors, functional blocks, and so forth. This may include implementation in hardware as an application specific integrated circuit or other logic device formed using one or more semiconductors. The hardware elements 910 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 906 is illustrated as including memory/storage 912. The memory/storage 912 represents memory/storage capacity associated with one or more computer-readable media. The memory/storage 912 may include volatile media (such as random-access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902 and also allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A computer-implemented method performed by a first computing device, the computer-implemented method comprising:
receiving, from a second computing device, video stream data comprising a plurality of frames and audio data;
obtaining, as output from at least one learning model, respective vector representations of the plurality of frames based at least in part on providing the plurality of frames as input to the at least one learning model;
determining, from the plurality of frames and the audio data, one or more items and one or more first characteristics of the one or more items based at least in part on the one or more items being associated with vector representations that match the respective vector representations of the plurality of frames within a threshold value;
determining one or more second characteristics of the one or more items,
comparing the one or more first characteristics to the one or more second characteristics to determine that the one or more second characteristics comprise at least one characteristic that is different from the one or more first characteristics; and
transmitting, for display at a third computing device, the video stream data and an indication that the at least one characteristic of the one or more items is different from the one or more first characteristics of the one or more items.

2. The computer-implemented method of claim 1, wherein determining the one or more first characteristics of the one or more items comprises parsing the audio data to obtain the one or more first characteristics of the one or more items.

3. The computer-implemented method of claim 1, wherein determining the one or more second characteristics of the one or more items comprises:
obtaining, as output from at least one additional learning model, an indication of one or more additional items that are within a threshold similarity to the one or more items; and
retrieving metadata for the one or more additional items, wherein the metadata comprises the one or more second characteristics.

4. The computer-implemented method of claim 1, wherein determining the one or more second characteristics of the one or more items comprises obtaining, as output from at least one additional learning model, the one or more second characteristics based at least in part on providing an indication of the one or more items and user information associated with the second computing device as input to the at least one additional learning model, wherein the one or more second characteristics are determined based at least in part on trend data corresponding to the user information.

5. The computer-implemented method of claim 1, wherein determining the one or more second characteristics of the one or more items comprises receiving, from the second computing device, sensor data that indicates the one or more second characteristics.

6. The computer-implemented method of claim 1, further comprising transmitting, for display at the second computing device, the indication that the at least one characteristic of the one or more items is different from the one or more first characteristics of the one or more items.

7. The computer-implemented method of claim 1, further comprising causing the third computing device to superimpose the at least one characteristic onto the video stream data in real time.

8. (canceled)

9. The computer-implemented method of claim 1, further comprising receiving, from the third computing device, a request for the at least one characteristic, wherein transmitting the at least one characteristic is based at least in part on the request, wherein at least one of the one or more first characteristics or the one or more second characteristics comprise respective categories of the one or more items, respective physical attributes of the one or more items, or respective conditions of the one or more items.

10. A computer-implemented method performed by a first computing device, the computer-implemented method comprising:
receiving, from a second computing device, video stream data comprising a plurality of frames and audio data;
obtaining, as output from at least one learning model, respective vector representations of the plurality of frames based at least in part on providing the plurality of frames as input to the at least one learning model;
determining, from the plurality of frames and the audio data, one or more items and one or more first characteristics of the one or more items based at least in part on the one or more items being associated with vector representations that match the respective vector representations of the plurality of frames within a threshold value;
determining one or more second characteristics of the one or more items, comparing the one or more first characteristics to the one or more second characteristics to determine that the one or more second characteristics comprise at least one characteristic that is different from the one or more first characteristics; and
outputting the video stream data and an indication that the at least one characteristic of the one or more items is different from the one or more first characteristics of the one or more items for display.

11. The computer-implemented method of claim 10, wherein determining the one or more first characteristics of the one or more items comprises parsing the audio data to obtain the one or more first characteristics of the one or more items.

12. The computer-implemented method of claim 10, wherein determining the one or more second characteristics of the one or more items comprises:
obtaining, as output from at least one additional learning model, an indication of one or more additional items that are within a threshold similarity to the one or more items; and
retrieving metadata for the one or more additional items, wherein the metadata comprises the one or more second characteristics.

13. The computer-implemented method of claim 10, wherein determining the one or more second characteristics of the one or more items comprises obtaining, as output from at least one additional learning model, the one or more second characteristics based at least in part on providing an indication of the one or more items and user information associated with the second computing device as input to the at least one additional learning model, wherein the one or more second characteristics are determined based at least in part on trend data corresponding to the user information.

14. The computer-implemented method of claim 10, wherein determining the one or more second characteristics of the one or more items comprises receiving, from the second computing device, sensor data that indicates the one or more second characteristics, wherein at least one of the one or more first characteristics or the one or more second characteristics comprise respective categories of the one or more items, respective physical attributes of the one or more items, or respective conditions of the one or more items.

15. The computer-implemented method of claim 10, further comprising transmitting, for display at the second computing device, the indication that the at least one characteristic of the one or more items is different from the one or more first characteristics of the one or more items.

16. The computer-implemented method of claim 10, wherein the outputting further comprises superimposing the at least one characteristic onto the video stream data in real time.

17. (canceled)

18. The computer-implemented method of claim 10, further comprising transmitting, to the second computing device, a request for the at least one characteristic, wherein receiving the at least one characteristic is based at least in part on the request.

19. A computer-implemented method performed by a first computing device, the computer-implemented method comprising:
transmitting, to a second computing device, video stream data comprising a plurality of frames and audio data, wherein the video stream data is associated with one or more items and one or more first characteristics of the one or more items based at least in part on the one or more items being associated with vector representations that match respective vector representations of the plurality of frames within a threshold value, and wherein the respective vector representations of the plurality of frames are output from at least one learning model; and
receiving, from the second computing device and based at least in part on a comparison between the one or more first characteristics and one or more second characteristics of the one or more items, the video stream data and an indication that at least one characteristic of the one or more second characteristics is different from the one or more first characteristics of the one or more items.

20. The computer-implemented method of claim 19, further comprising outputting a notification for display that the at least one characteristic is different from the one or more first characteristics, wherein the at least one characteristic is superimposed onto the video stream data in real time, and wherein at least one of the one or more first characteristics or the at least one characteristic comprise respective categories of the one or more items, respective physical attributes of the one or more items, or respective conditions of the one or more items.

21. The computer-implemented method of claim 1, further comprising determining, based at least in part on performing key frame detection on the plurality of frames, a subset of frames of the plurality of frames comprising visual information, wherein the subset of frames is provided as input to the at least one learning model.

22. The computer-implemented method of claim 10, further comprising determining, based at least in part on performing key frame detection on the plurality of frames, a subset of frames of the plurality of frames comprising visual information, wherein the subset of frames is provided as input to the at least one learning model.
